(19) United States
(12) Patent Application Publication
(10) Pub. No.: US 2023/0032078 A1
(43) Pub. Date: Feb. 2, 2023

(54) On-Board Charging System for Electric Vehicle

(71) Applicant: Regnault Umaru Bamiji, Abuja (NG)

(72) Inventor: Regnault Umaru Bamiji, Abuja (NG)

(21) Appl. No.: 17/751,404

(22) Filed: May 23, 2022

Related U.S. Application Data
(60) Provisional application No. 63/192,472, filed on May 24, 2021.

(51) Int. Cl. H02J 7/16; B60L 53/50; B60L 50/60; H02J 7/14; H01M 10/44

(52) U.S. Cl. CPC H02J 7/16; B60L 53/50; B60L 50/66; H02J 7/1423; H01M 10/441; H01M 2220/20

(57) ABSTRACT

An on-board charging system for an electric vehicle comprising a generator (Dynamo) 1, coupled to the wheel of the electric vehicle. The generator produces a charging voltage which is connected to a 12 V battery, via voltage regular, the 12 V battery, and is connected to the input of a Power Boaster, which boasts the voltage from 12 V at the input to 48 V at the output. A Dual battery isolator is connected between the secondary Lithium battery and the Main lithium battery, that supply power to the a gear drive of the electric vehicle. When there is a drop in the voltage of the main lithium battery, during operation, the intelligent dual battery isolator triggers a release of the stored voltage from the secondary lithium battery pack to instantaneously charge up the main lithium battery, supplying power to the electric vehicle drive.

### CROSS-REFERENCE TO RELATED APPLICATIONS

This application claims the benefit of priority of U.S. Provisional Application No. 63/192,472 filed on May 24, 2021, the disclosure of which is incorporated herein by reference in its entirety.

### FIELD OF THE INVENTION

The present invention relates, in general, to a battery charging system for an electric vehicle; specifically, to an on-board charging system for an electric vehicle.

### BACKGROUND OF THE INVENTION

There are charging stations for electric vehicle spread all over developed countries, but in developing countries like in Africa countries, such charging stations are not available, making driving electric cars cumbersome or impossible. Even in developed countries, there are instances where many electric car owners complained about towing their cars, because the batteries have completely depleted and cannot power the vehicle. They have no option than to pay and tow the vehicle to the next available charging station. Hence, making the electric car uninteresting and cumbersome. In African countries that have serious issues of electricity provision, it becomes impossible to drive such cars in that region. Even if electric car owners decided to charge the electric car batteries at home with grid power or a generator, what happens when the battery is depleted while driving the car? Since there are no charging station, it means towing the car home, it make electric cars cumbersome and uninteresting.

### SUMMARY OF THE INVENTION

Some or all of the above needs and/or problems may be addressed by certain embodiments of the disclosure. In accordance with the purposes of the disclosure, as embodied and broadly described herein, the disclosure, in one aspect, relates to an on-board battery charging system for electric vehicles.

The on-board battery charging system for electric vehicles comprises a generator (dynamo). The generator (dynamo) is connected to the wheels of the electric car, at a ratio of 1:30, which means when the electric car wheels spins 1 revolution, the generator (dynamo) spins 30 revolutions. This can be done either by connecting the two via belt or the dynamo is allow to roll on the wheel while the vehicle is driving. This generates a charging current. It must be noted that the generator/dynamo used in this description is a small generator/dynamo which will have negligible effects on the wheels and will not retard the speed of the automobile. For example, if the small generator/dynamo coupled to the spinning wheels is 12V 20A, this will not affect the speed of the automobile. The 12V 20A output of the generator/dynamo is eventually multiplied to charge 48V and above batteries of the electric vehicle as will be describe in the body of this specification. The on-board charging system consists of the generator (dynamo), DC voltage regulator, 12V battery, power booster, lithium batteries for the electric car, dual batteries isolators.

### BRIEF DESCRIPTION OF THE DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawing, which are provided to illustrate, not limit, the scope, wherein similar designations denote similar elements.

FIG. 1 illustrates an exemplary on-board charging system for electric cars.

FIG. 1 illustrates an exemplary diagram of a portion of the system to include the gear drive 8.

FIG. 1. Illustrates additional lithium batteries pack 7 added to the system.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

Whenever appropriate, terms used in the singular also will include the plural and vice versa. The use of ‘a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The following description is provided as an enabling teaching of the disclosed articles, systems, and methods in their best, currently known embodiments. To this end, those skilled in the relevant art will recognize and appreciate that many changes can be made to the various aspects of the articles, systems, and methods described herein, while still obtaining the beneficial results of the disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a gasket” can include two or more such gaskets unless the context indicates otherwise.

As used throughout, “substantially” with respect to a measure can refer to a range of values comprising +/−O degrees. For example, substantially orthogonal, normal, or parallel can include embodiments, where the referenced components are oriented +/−10 degrees of being classified as orthogonal, normal, or parallel respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

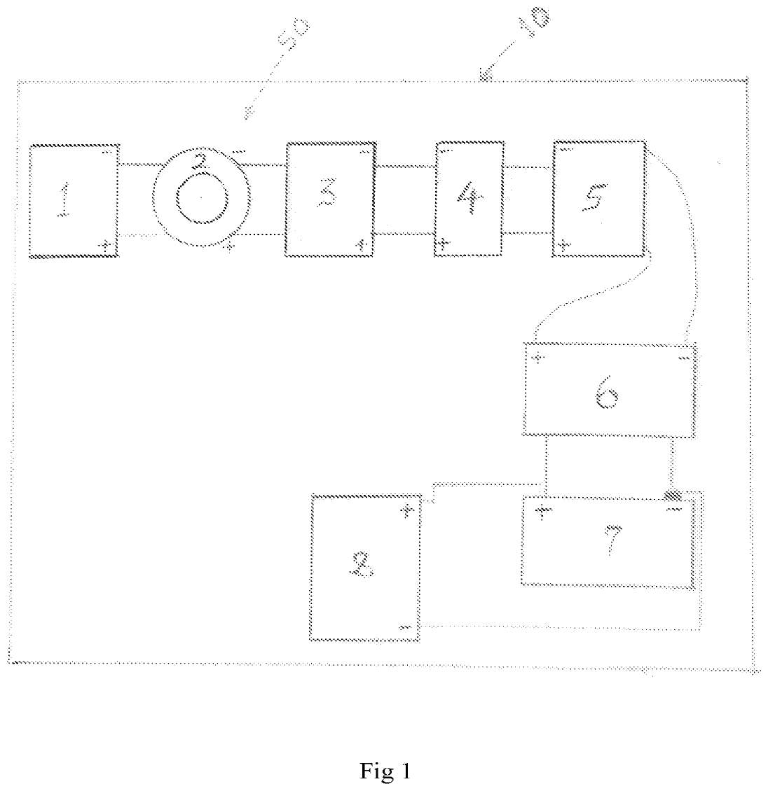

FIG. 1 depicts a schematic of an environment 10 with the on-board battery charging system 50 The on-board battery charging system 10 can comprise a generator (dynamo) 1, a voltage regular (DC) 2, 12 V battery 3 (to stabilize voltage generated from the generator/dynamo), a power boaster 4 (for example, boosting voltage from 12V to 48V), main lithium battery Pack 5, dual battery isolator 6, secondary lithium battery pack 7, gear drive for electric car 8.

As shown in FIG. 1, the system 50 can include an internal battery 3. The internal battery 3 can comprise a rechargeable battery. In a further aspect, the internal battery 3 can be a lithium battery. In yet a further aspect, the rechargeable battery can comprise a plurality of cells. For example, as shown in FIG. 1, the plurality of cells can be electrically connected to define a battery with a larger voltage potential. The voltage potential of the system prior to the power booster 4 can be 12V. In another aspect, the internal battery 3 can comprise 18650 type or 18630 type lithium packs/cells.

The generator (dynamo) can be coupled to the wheels of the electric car, either by drive belt or directly and allowed to roll and spin on one wheel of the automobile, to the ratio of 1:30, so when the wheel spins once, the dynamo 1 spins 30 times. In the process it generates a charging voltage and this charging voltage is connected to a 12V battery 3 via a voltage regulator to stabilize the voltage generated and to charge the 12V battery 3, a power booster 4 is further connected to the 12V battery 3. The input of the power booster 4 is 12 v connected from the 12V battery 3 and the power is boosted from 12V to 48. This is for illustrating purpose, larger voltages can be used. The 48V output from the power booster is now connected to the secondary lithium battery 5 of the system, to charge and store the voltage.

A dual battery isolator 6, is now connected between the secondary lithium battery 5 and the main lithium battery 7, the dual battery isolator is an intelligent device that observes any drop of voltage in the main lithium battery that powers the electric car. For illustration purposes, if the dual battery isolator observes or senses a drop in voltage from 48V to 30V of the main lithium battery 7, it immediately triggers and opens a connection between the main lithium battery 7 and the secondary lithium battery 5. Hence, the stored voltage at the secondary lithium battery is released from the stored voltage to charge up the main lithium battery that is powering the drive of the electric car.

What is claimed:

1. An On-Board Charging system for electric vehicles comprises of a Generator (Dynamo) 1, a voltage regular 2, and a 12V battery 3, which stabilizes the voltage generated due to the spinning of the Generator (dynamo) coupled to the wheel of the electric car.

2. An On-Board charging system for electric Vehicles according To claim 1, the voltage generated by the spinning of the generator (dynamo) is regulated by the voltage regular 2 and is stabilized on the 12V battery 3, Thel2V battery 3 is connected to the input of the Power Boaster 4, which Boast the voltage from 12V to 48V.

3. An On-board charging system for electric vehicles according to claim 2, when the power Boaster 4 has boasted the voltage from 12V to 48V, it charges secondary Lithium battery pack 5 and stored the voltage there until needed by the main lithium battery 7.

4. An On-Board Charging system according to claim 3, a dual battery isolator is connected between the main lithium battery pack 7 and the secondary lithium battery pack 5, which intelligently observe drop of voltage in the main lithium battery 7, that supply power to the electric car drive, when there is a drop in voltage, it trigger a release of the stored voltage from the secondary Lithium battery 5 to the main lithium battery pack 7 charging it instantaneously.

5. An On-Board Charging system for Electric vehicles according to claim 4, where the main lithium battery 7 is connected to the drive of the electric car to supply power to the gear/drive of the electric vehicle, when the voltage depleted due to use, it is replenished by the charging current received from the secondary lithium battery pack 5 via the dual battery isolator 4.
